(19) United States
(12) Patent Application Publication
(10) Pub. No.: US 2006/0215025 A1
(43) Pub. Date: Sep. 28, 2006

(54) Method for the recognition of a chronicle, device and corresponding computer program

(75) Inventors: Pierre Le Maigat, Trebeurden (FR); Christophe Dousson, Lannion (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: France Telecom, Paris (FR)

(21) Appl. No.: 11/373,522

(22) Filed: Mar. 10, 2006

(30) Foreign Application Priority Data
Mar. 10, 2005 (FR) 05/02394

(51) Int. Cl. H04N 7/18

(52) U.S. Cl. 348/143

(57) ABSTRACT

In a method of recognition of a chronicle from a set of possible chronicles, each of said chronicles consists of a set of events related to one another by pre-determined conditions, said events comprising elementary events and complex events corresponding to a specific combination of at least two elementary events. The method comprising the following steps: obtaining a series of elementary events; determining at least one chronicle, called a presumed chronicle, that meets at least certain of said conditions interrelating said elementary events, from among said set of possible chronicles; and for each of said presumed chronicles, identifying at least one complex event that has to be present in said presumed chronicle; verifying the presence of said complex event from corresponding elementary events; confirming the recognition of said chronicle if said complex event or events are present; so that only the complex events necessary for said recognition are computed.

### CROSS-REFERENCE TO RELATED APPLICATION

None.

### FIELD OF THE DISCLOSURE

The field of the disclosure is that of real-time supervision, i.e. the surveillance or monitoring of the development and progress of a system in real time.

More specifically, the disclosure relates to a technique for recognizing and interpreting scenarios online through the observation of event streams.

One or more embodiments can be used especially to detect and/or interpret scenarios of malfunctions through the tracking of one or more parameters (for example the absence of signals or a crossing of a threshold), scenarios of attacks on a network through the observation of alarms (generated for example by the equipment of a telecommunications network) and/or the detection of abnormal entry events, or again the interpretation of scenes from events coming from one or more video sequences.

Such scenarios may be represented (or formalized) especially by chronicles taking account of the relationships of temporal causality between several observations. A chronicle thus consists of a set of events related to one another by pre-determined conditions, such as time-related constraints, or a certain number of occurrences of an event, etc.

### BACKGROUND OF THE DISCLOSURE

1. The chronicles

In the surveillance of a telecommunications network for example, the events encountered (also called observations) may be of the “loss of signal”, “loss of frame”, “link down” and other types.

FIG. 1 illustrates an exemplary chronicle, specifying the different events that could occur and the permissible time intervals between two events (shown in square brackets).

Thus, according to this example of a chronicle, at least 1 second and at most 2 seconds should elapse between a “loss of frame active” LOF_{active} type event 11 and a “link down” LD type event 12.

In other words, the observation LOF_{active} 11 must take place between 1 and 2 seconds before the observation LD 12.

This chronicle also specifies that:
the “loss of signal active” LOS_{active} type event 14 should occur at the earliest 1 second before and at the latest 6 seconds after the LOF_{active} event 11;
the “loss of frame clear” LOF_{clear} type event 13 must occur at the earliest 5 seconds and, at the latest, 60 seconds after the LOF_{active} event 11;
the “link up” LU type event 15 must occur at the earliest 2 seconds and at the latest 10 seconds after the LOF_{clear} event 13;
the “loss of signal clear” LOS_{clear} type event 16 must occur at the earliest 1 second and at the latest 6 seconds after the LOF_{clear} event 13.

Thus, an instance of a recognized chronicle could be:

(LOF_{active}, 0) (LD, 2) (LOF_{clear}, 5) (LOS_{active}, 6) (LU, 7) (LOS_{clear}, 11) or again:

(LOF_{active}, 12) (LOS_{active}, 13) (LD, 15) (LOF_{clear}, 18) (LOS_{clear}, 19) (LU, 28) where the pair (x, t) indicates that the occurrence of the event x takes place on the date t.

2. Chronicle Recognition

The recognition of chronicles is a technology that performs well in the context of the supervision of dynamic and/or complex systems, for example telecommunications networks, in which a very great volume of events has to be supervised.

The general principle of a chronicle recognition system relies on an online recognition of these temporal schemes in a stream of observations picked up by a recognition system, as presented by Dousson and al. in “Situation Recognition: Representation and Algorithms” (Proceedings of the 13th IJCAI, August 1993), “Suivi d'evolutions et reconnaissance de chroniques” (“Tracking of developments and chronical recognition”, thesis presented at the Université Paul Sabatier, September 1994), and “Extending and Unifying Chronicle Representation with Event Counters” (Proceedings of the 15th ECAI, July 2002).

Referring to FIG. 2, the general principle of a prior art chronicle recognition system is presented.

Classically, a stream of observations 21 (consisting of elementary events, such as for example alarms) is processed in a collector 22 which picks up and/or retrieves observations on the system under surveillance. This collector 22 picks up and/or retrieves the elementary events as and when they arrive and forwards them to a recognition engine 23 which compares them with a base of chronicle models 24 and integrates the recognized events into one or more chronicles.

Such a collector 22 also has means 26 for the pre-processing of the observations. These pre-processing means 26 can be used especially to compute complex events, i.e. events that require complex processing, from a combination of elementary events. In other words, a complex event may be considered to be a scenario of elementary events.

Indeed, certain observations must undergo pre-processing before they can be integrated, if necessary, into a chronicle.

Thus, in the example where the observations rely on a sampling of a continuous signal, certain observations sent back may relate to a simple crossing of value thresholds (elementary events) while others are computed from the sample, such as for example the moving average, the Fourier transform, estimation of derivatives, shape recognition etc (complex events) and therefore call for processing of greater complexity.

This type of recognition therefore necessitates the addition of means 26 for the pre-processing of observations, for example a signal processing unit. This unit may, if necessary, be external to the collector 22.

The recognition engine 23 then delivers a chronicle 25 (or a chronicle instance) recognized as a function of the elementary events and the complex events that have been computed and previously recognized, the events being integrated into the possible chronicles as and when the observed events (of an elementary or complex type) occur.

It must be emphasized here that the chronicle recognition is done according to the order of arrival of the observations/events and not according to their date of occurrence.

Although such a technique of recognition offers efficient synthesis of alarms and fast detection of malfunctions, it is ill suited to the recognition of observations that require pre-processing, namely complex types of observations.

Indeed, according to prior art techniques, a computation of all the complex events (namely of all the types of observations possible) is implemented as soon as the collector receives the different observations, in order to give the recognition engine all the possible (elementary and complex) events.

Hence, computations are unnecessarily made on a large number of complex events, even if these events do not have to be taken into account in the recognition of one instance of a chronicle from among a set of known chronicle models.

This unnecessary computational overload may cause major slowdowns in the recognition process and may severely affect the efficiency of online diagnostics, for example by sending back a recognition result in a period of time that is far too great relative to the recognition constraints necessary (for example for activating a security system etc).

### SUMMARY

An embodiment of the present invention is directed to a method of recognition of a chronicle from a set of possible chronicles, each of the chronicles comprising of a set of events related to one another by pre-determined conditions, the events comprising elementary events, and complex events corresponding to a specific combination of at least two elementary events.

According to an embodiment of the invention, a method of this kind comprises a set of steps for obtaining a series of elementary events, determining at least one presumed chronicle from the set of possible chronicles meeting at least certain of the conditions linking the elementary events, and, for each of the presumed chronicle, steps for identifying at least one complex event that has to be present in the presumed chronicle, verifying the presence of the complex event from the corresponding elementary events, and confirming the recognition of the chronicle if the complex event or events are present, so that only the complex events necessary for said recognition are computed.

Thus, an embodiment of the invention relies on a wholly novel and inventive approach to the recognition of a chronicle in real time, enabling the simplification of the processing operations for chronicle recognition.

Indeed, this technique does away with the problems of computational overload affecting prior art chronicle recognition systems by proposing the computation of only those complex events that are necessary for recognition while the classic technique consists of the computation of all the complex events to provide the recognition engine with all the events (elementary and complex) whether or not these events belong to a possible chronicle.

In the prior art, complex events that are not necessary for recognition are computed unnecessarily.

Preferably, the pre-determined conditions are time-related constraints and/or a number of occurrences of at least one predefined event linking the elementary and complex events of a chronicle to one another.

For example, a chronicle may specify that an event A must come about at the earliest 1 second before and at the latest 3 seconds after an event B. Similarly, a chronicle may specify that, between the events A and B, there must be 2 occurrences of an event C.

Advantageously, for each identified, complex event, the verification step is implemented in a time window determined on the basis of the corresponding elementary events and of at least some of the conditions of the presumed chronicle.

Thus, when the computation of a complex event is indispensable, an embodiment of the invention can be used to define a time window in which the presence of this event must be verified.

In particular, this time window starts at the earliest date of occurrence and ends at the latest date of occurrence of the identified complex event.

Indeed, this time window is determined in taking account of at least one elementary event and of the pre-determined conditions linking this event or these events to the complex event identified.

The previous example is taken up again, in assuming a chronicle which specifies that an event B must occur at the earliest 1 second before an event A and at the latest 3 seconds after this event A, and assuming that A is an elementary event and B is a complex event. If the event A appears at the date t=10, then the recognition engine knows that the complex event B must appear in the time window [9, 13], and will verify the presence of the complex event identified in this window.

This time window may also be defined by the intersection of at least two time intervals computed on the basis of the date of occurrence of at least one elementary event and of the pre-determined conditions.

Indeed, if the chronicle specifies that the event B must happen at the earliest one second before the event A and at the latest three seconds after this event A, and between two seconds and six seconds after the event C then, if the event A appears at the date t=10, and the event C appears at the date t=8, the event B must appear in the time window defined by the intersection of the intervals [9, 13] and [10, 14], i.e. in the time window [10, 13].

Preferably, the computed complex events are stored in the form of at least one new elementary event.

Thus, it is not necessary to re-compute the complex events once they have been computed. A computed complex event then becomes an elementary event and may be used as an elementary event in another chronicle.

Advantageously, the elementary events are stored for a storage period determined from the time-related constraints of the presumed chronicle.

This storage period, defined on the basis of the time-related constraints of the chronicle, thus ensures the use of a finite-sized memory, and hence the technical feasibility of an embodiment of the invention.

Preferably, each of the complex events of the set of possible chronicles has an associated value of computational complexity and, in each of the chronicles, a hierarchical structuring of events is carried out as a function of this value, the identification step being used to identify the complex events having a value below a predetermined threshold.

Thus, according to an embodiment of the invention, the events of lower complexity, namely the complex events having a value below a certain threshold, are processed by priority. Once these events have been recognized, the method of an embodiment of the invention determines the events of higher complexity and processes these events.

An embodiment of the invention also provides for a hierarchical computation of the complex events as a function of their level of complexity, i.e., as a function of the time needed to recognize these events, so that the most complex events are computed only if this computation is indispensable.

An embodiment of the invention also relates to a device for the recognition of at least one chronicle among a set of corresponding chronicles, as well as to a computer program comprising program code instructions for the execution of the steps of the method of recognition of at least one chronicle described here above when said program is executed by a microprocessor.

Other features and advantages of one or more embodiments of the invention shall appear more clearly from the following description, given by way of a simple, non-restrictive illustration, and from the appended drawings.

### BRIEF DESCRIPTION OF THE DRAWINGS

FIG. 1, which has already been presented with reference to the prior art, illustrates a model of a chronicle, with the time-related constraints (between square brackets) that these events must meet.

FIG. 2, also presented with reference to the prior art, illustrates the general principle of chronicle recognition according to the prior art;

FIG. 3 presents the general principle of chronicle recognition according to an embodiment of the invention.

FIG. 4 presents a second exemplary implementation of an embodiment of the invention in which the recognition system of FIG. 3 interprets video surveillance scenes.

FIG. 5 presents a third exemplary implementation of an embodiment of the invention in which the recognition system of FIG. 3 recognizes a scenario by interpreting curves representing the development and progress of certain parameters.

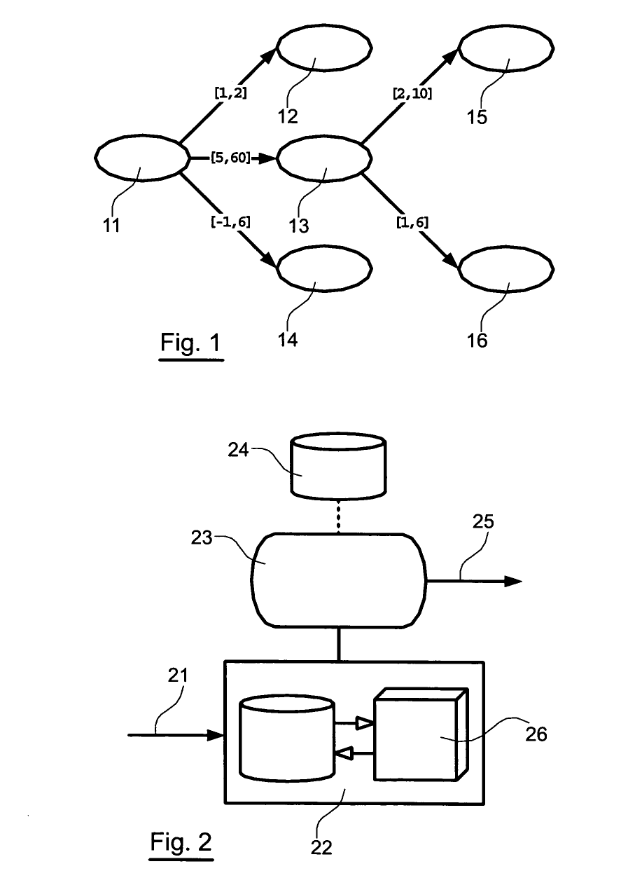

### DETAILED DESCRIPTION OF ILLUSTRATIVE EMBODIMENTS

1. General Principle of an Embodiment of the Invention

The general principle of an embodiment of the invention relies on a hierarchical structuring of events as a function of their level of computational difficulty, namely, as a function of the time needed to recognize these events, in assuming that the elementary events require little computation time while the complex events, corresponding to a specific combination of elementary events, call for greater computational time.

According to an embodiment of the invention, the recognition engine first of all integrates the elementary events into at least one presumed chronicle and then, depending on the integrated elementary events and on the time-related constraints that link together the events of one and the same presumed chronicle, it determines the time window in which a complex event of the presumed chronicle must be situated.

The collector then computes the complex event identified, as well as its date of occurrence, and verifies that this event is effectively present in the determined time window.

Then, in the determined time window, the collector computes the complex event identified, as well as its date or dates of occurrence in said time window.

An embodiment of the invention thus proposes a decoupling of the elementary events (of a simple type) and of the complex events (of a composite type) to enable a hierarchical structuring of events as a function of their computational complexity.

This approach is therefore an “a-temporal” approach by which the collector can be both alerted to the fact that it must monitor the appearance of a complex event in a time window situated in the future and made to carry out a search in a time window from the past.

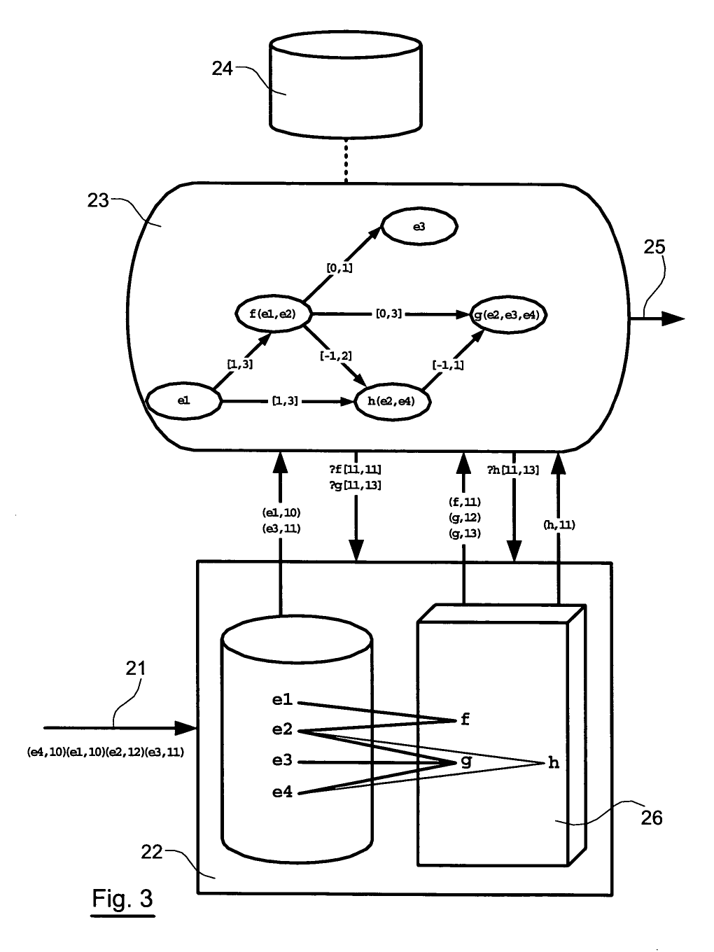

Referring now to FIG. 3, the general principle of the recognition technique of an embodiment of the invention is presented.

As described already with reference to FIG. 2, a stream of observations 21, consisting of elementary events, is processed in a collector 22 which retrieves the observations of the system under surveillance and transmits these observations to the recognition engine 23, for example the CRS (Chronicle Recognition System) engine proposed by Dousson et al. and presented with reference to the prior art.

According to an embodiment of the invention, the recognition engine 23 may, in particular, structure the different events hierarchically as a function of the level of computational difficulty, for each model of chronicle.

In one variant of the invention, it can also be envisaged that this hierarchical structuring of the different events will not be activated by default but can be activated optionally by an informed user or else that it can be activated automatically, as soon as the volume of events contained in the stream to be processed in real time crosses a certain threshold.

In the example of FIG. 3, where a possible chronicle is formed by elementary events e1, e2, e3 and e4 and complex events f, g and h, the events e1, e2, e3, e4 will be level 1 events, the events f and g will be level 2 events and the event h will be a level 3 event, where level 3 corresponds to the highest value of complexity.

Furthermore, for each model of chronicle, the recognition engine 23 associates, with each event, the list of lower-level events enabling its computation: the event f is determined from the events e1 and e2, the event g is determined from the events e2, e3 and e4, and the event h is determined from the events e2 and e4.

Furthermore, for each model of chronicle, the recognition engine 23 associates, with each event, the list of higher-level events which can be computed: the event e1 plays a role in determining the event f, the event e2 plays a role in determining the events f, g and h, the event e3 plays a role in determining the event g, and the event e4 plays a role in determining the events g and h.

According to an embodiment of the invention, the collector 22 receiving the stream of observations 21 comprises pre-processing means 26, also called pre-computation means.

It can also store the history of the system under surveillance, or at least a part of this history so that the computation of a complex event by the pre-processing means 26 will be preserved and can be subsequently re-utilized.

Thus, as soon as a complex event is computed (along with its date or dates of occurrence) it could be integrated into a “database” and could serve in the computation of other complex events.

Let us consider for example a stream of observations 21 consisting of the elementary events e1, e2, e3 and e4 received by the collector 22 in the following order: (e4, 10) (e1, 10) (e2, 12) (e3, 11), with the pair (x, t) specifying that the occurrence of the event x takes place on the date t.

According to an embodiment of the invention, the collector 22 initially sends up only the available observations, pending the command from the recognition engine 23 to carry out the computation of the complex events in order to send them back to the engine.

More specifically, an event is deemed to be available for the collector when it is an elementary event coming from the system under surveillance or when it is a complex event already computed by the pre-computer 26 and preserved in memory.

Thus, when an event is available, the collector 22 forwards the event to the recognition engine 23 which (in one operation) tries to integrate it into all the possible chronicles of the base of chronicle models 24. The collector 22 then checks to find out whether this event belongs to one or more lists of higher-level events. If the response is negative, the event is not stored. If the response is positive, it is stored for a certain storage period. This storage duration thus ensures the existence of a collector 22 with a finite memory.

This storage duration of an available event is determined, for example, by evaluating the lifetime of a chronicle, for each model of chronicle or instance of chronicle in which the event occurs, this lifetime of the chronicle being the maximum duration between the last integrated event and the highest value of the latest dates of the events remaining to be integrated. The maximum authorized time difference is then added for all the possible events that have not yet occurred for the chronicle, namely those events which can be directly integrated and those events that occur in higher-level events (in assuming that the recognition engine enables a user to specify, for each event, a maximum authorized delay between its date of occurrence and its date of arrival at the engine in order to take account of the possibility that the different events happen in an order different from that of their effective date of occurrence). The duration obtained is the lifetime of the event relative to this chronicle. To obtain this storage duration, we take the greatest of the lifetimes of the event relative to all the chronicles (models and instances).

Thus, in resuming the example of FIG. 3, and in assuming that the events e4, e1 and e2 arrive at the engine 23 instantaneously, i.e. respectively at the dates d4=10, d1=10 and d2=12, and that the maximum authorized delay for the event e3 is 5 seconds, then the maximum authorized date of occurrence for the event e3 to be integrated into the chronicle will be d=11+5=16 seconds.

When the event e4 arrives, it potentially initiates an instance of the chronicle at d=10. The lifetime of the chronicle is then 4 seconds. The 5 seconds of possible delay of the event e3 are then added on. The storage duration is therefore 4+5=9 seconds. Thus, if the dates of the events are such that the recognition engine 23 does not ask for the computation of the events g or h, the event e4 will be erased from the collector 22 at the date d=19. The 9-second delay is enough therefore for the full recognition of the chronicle.

Similarly, when the event e2 is available, only the event e1 has been integrated and the lifetime of the chronicle is therefore still 4 seconds. The possible delay of the event e3 is then added. The storage duration is therefore equal to 4+5=9 seconds for the event e2. The event e2 will therefore be erased at d=12+9=21 seconds. This is sufficient for the recognition of the chronicle.

Thus, in addition to the elementary events, the collector 22 can also send back the complex events stored in the collector 22, i.e. the complex events that have already been computed for other chronicles for example, to the recognition engine 23 and preserve these events for a certain duration of storage.

In this example, the presumed chronicle consists of the elementary events e1, e2, e3, e4, and complex events f, g and h, which have never been computed hitherto.

The collector 22 sends the elementary events e1 and e3 back to the recognition engine 23 as soon as they are available. Thus, the collector 22 informs the engine 23 that an occurrence of the event e1 (and e3 respectively) has taken place at the date t=10 (and t=11 respectively).

The recognition engine 23 thus determines at least one presumed chronicle, among the possible chronicles of the base of chronicle models 24 comprising the elementary events e1 and e3 and meeting at least certain conditions that relate these events to one another. The engine 23 thus verifies that the event e1, which has appeared at the date t=10, and the event e3, which has appeared at the date t=11, are truly temporarily correlated for the presumed chronicle.

Once the elementary events have been integrated and once at least one presumed chronicle has been determined, the recognition engine 23 computes the time windows relevant to the complex events which have not yet been integrated, and orders the collector 22 to carry out the search/computation pertaining to these complex events on these time windows. These time windows are determined as a function of the time-related constraints interrelating the events of the presumed chronicle and, as the case may be, the number of occurrences of an event over a given period.

Thus, knowing that the complex event f must take place between 1 and 3 seconds after the elementary event e1, and between 0 and 1 seconds before the event e3 (these conditions are determined beforehand in the presumed chronicle) and that the date of occurrence of the events e1 and e3 is respectively t=10 and t=11, the recognition engine 23 determines that the relevant time window for the search of the event f is the interval [11, 11].

Similarly, the complex event g, determined from the elementary events e2, e3 and e4, appears at the earliest 0 seconds and at the latest 3 seconds after the event f. Knowing that the date of occurrence of the event e3 is t=11 and that the event f appears at the earliest one second before the event e3, the recognition engine 23 determines that the relevant interval for the search for the event g is the interval [11, 13].

The engine 23 then asks the collector 22 to compute/search for the complex events f and g in these intervals.

It is assumed for example that the collector 22 finds an occurrence of the event f at t=11, and finds an occurrence of the event g at t=12 and another occurrence at t=13.

We are therefore potentially in the presence of the instance of a chronicle C1=(e1, 10)(e3, 11)(f, 11)(g, 12) or the instance of a chronicle C2=(e1, 10) (e3, 11) (f, 11) (g, 13) of the presumed chronicle.

The recognition engine 23 then determines the relevant intervals for the complex event h, having a level higher than that of the complex events f and g.

If it is assumed that the event e1 arrives at the date t=10, that the event f arrives at the date t=11, and that the event g arrives at the date t=12, then the relevant interval for the search for the event h is the interval [11, 13].

If it is assumed that the event e1 arrives at the date t=10, that the event f arrives at the date t=11, and that the event g arrives at the date t=13, then the relevant interval for the search for the event h is the interval [12, 13].

The collector 22 then searches for the occurrences of the event h in the interval [11, 13], corresponding to the combining of the intervals [11, 13] and [12, 13]. For example, it finds an occurrence of the event h at t=11.

The presumed chronicle is then recognized for the dates (e1, 10) (e3, 11) (f, 11) (g, 12)(h, 11).

Thus, according to an embodiment of the invention, the complex events are computed only if they need to be computed, and these events are computed in the order of their level of difficulty.

In this example, the complex events f and g, having a level 2 complexity, are therefore computed before the event h, having a level 3 complexity, the level of complexity being determined, for example, by an expert.

Thus, according to an embodiment of the invention, should the complex event g arrive at a date incompatible with the chronicle being recognized (presumed chronicle), the computation of the complex event h will not be done (although the event h temporally precedes the event g).

An embodiment of the invention thus provides for savings in computation power, especially when the computation of the event h is very costly in terms of resources.

By contrast, according to the techniques of the prior art, the complex events f, g and h are computed as soon as the observations by which they can be computed are available. Thus, the event h would have been searched for/computed as soon as the elementary events e2 and e4 arrived at the collector.

Taking up the above example again, if the collector had received the stream (e4, 10) (e1, 10) (e2, 12) (e3, 11), it would have forwarded the pair (e1, 10) to the recognition engine, and then it would have computed the events f(e1, e2) and, simultaneously, h(e2, e4), and finally it would have transmitted the pair (e3, 11) and computed the complex event g(e2, e3, e4).

According to the prior art, all the complex events would have been computed without any concern for compliance with the conditions described beforehand in the chronicles.

2. First Example of Implementation of the Invention

We shall now present a first example of an implementation of the invention for the detection of “naïve” servers/routers implicated in a reflected distributed denial of service (RDDoS) attack.

In brief, this type of attack takes place as follows: an attacker (a user or a remote server) takes over the address of its target (terminal or server) and, with this address, send connection demands (SYN) to servers and routers known as “naïve” routers i.e. innocent routers in the sense that these servers and routers are used unwillingly in the attack.

The “naïve” servers and routers send SYN/ACK packets to the target in order to set up connection. The fact that a large number of servers/routers is brought into play causes jamming (and hence a denial of services) for the target server.

The attack may be defined by a very high rate for the SYN/ACK packets sent from the routers to the target and, at the level of the “naïve” elements by a higher-than-average rate of SYN packets coming from the target (attack scenario).

It can be noted that the SYN packet rates are not always high enough to set off alarms (i.e. such activation of alarms could be excessively frequent, excessively costly to compute or not representative of a true SYN attack).

In this example, it is sought to identify the “naïve” elements of the network that come into play in an RDDoS attack. The example takes the case of the network for which the routers have a probe sending back information on a sample of the streams passing through these routers.

After this information is filtered, all that is retained is, for example, the packet rates, the source address and the destination addresses of the stream. Thus, an event TWL[@SOURCE,@DEST] (TWL=“Traffic Warning Low”) represents a stream going from the source address “@SOURCE” to the destination addresses “@DEST” with a SYN packet rate higher than that of a predetermined first threshold, and an event TWH[@DEST] (TWH=“Traffic Warning High”) represents a stream going towards the destination address “@DEST” with a SYN/ACK packet rate above a predetermined second threshold.

Thus, we consider a chronicle specifying that the server located at the address “@DEST” of the event TWL[@CIBLE,@DEST] is implicated in an RDDoS attack against the target situated at an address <<@CIBLE >> (in TWH[@CIBLE]), the events of the chronicles being related to one another by the following predetermined conditions:
the event TWH[@CIBLE] must appear twice between the events TWH[@CIBLE]_I and TWH[@CIBLE]_F;
the event TWL[@CIBLE,@DEST], must appear three times between the events TWL[@CIBLE,@DEST]_I and TWL[@CIBLE,@DEST]_F;
the events TWL[@CIBLE,@DEST]_F and TWL[@CIBLE,@DEST]_I are spaced out by at least 0.5 seconds and at most one second;
the events TWH[@CIBLE]_I and TWL[@CIBLE,@DEST]_I are spaced out by 10 seconds at most;
the events TWH[@CIBLE]_F and TWH[@CIBLE]_I are spaced out by one second at most.

Let us consider the following stream of observations:

```
  1: TWL[xx, yy]
  2: TWL[xx, yy]
  3: TWH[zz]
  4: TWL[aa.bb.cc.dd, pp.qq.rr.ss]
  5: TWL[aa.bb.cc.dd, ll.nn.mm.oo]
  6: TWL[aa.bb.cc.dd, ll.nn.mm.oo]
  7: TWL[xx, yy]
  8: TWL[aa.bb.cc.dd, tt]
  9: TWH[aa.bb.cc.dd]
10: TWL[aa.bb.cc.dd, ll.nn.mm.oo]
11: TWL[aa.bb.cc.dd, pp.qq.rr.ss]
12: TWH[aa.bb.cc.dd]
13: TWL[aa.bb.cc.dd, pp.qq.rr.ss]
14: TWL[aa.bb.cc.dd, tt]
15: TWH[aa.bb.cc.dd]
16: TWH[aa.bb.cc.dd]
17: TWH[aa.bb.cc.dd]
18: TWH[aa.bb.cc.dd]
```

with aa.bb.cc.dd, xx and zz being the addresses of the target, ll.nn.mm.oo, pp.qq.rr.ss, yy, and tt the addresses of the servers and routers.

According to an embodiment of the invention, the recognition engine especially ascertains that the condition of occurrence of the event TWH[@CIBLE] between the events TWH[@CIBLE]_I and TWH[@CIBLE]_F is verified before the other complex events are computed.

Thus, the engine waits for the events referenced 9 and 12 before computing more complex events.

With this first condition verified, the recognition engine asks the collector for TWL[@CIBLE,@DEST] type events that have occurred 10+1=11 seconds at the earliest before the event TWH[@CIBLE].

The collector sends the recognition engine the events referenced 4, 5, 6, 8, 10, 11, 13 and 14. The engine integrates the events referenced 4, 11, 13 and 5, 6, 10 into the chronicle, thus recognizing the chronicle and identifying the servers pp.qq.rr.ss and ll.nn.mm.oo as taking part in the attack.

For its part, the collector keeps the TWL type events for only 10+1=11 seconds (maximum size of the chronicle).

In the prior art, on the contrary, a large number of presumed chronicles will have been created since the events referenced 1, 2 and 7 for example form the beginning of a chronicle for an attack on the address of the target “@xx” Furthermore, since the TWL type events precede the TWH type events for a same target and since the TWL type events are very frequent, the prior art technique would have performed a large number of unnecessary computations.

3. Second example of Implementation of the Invention

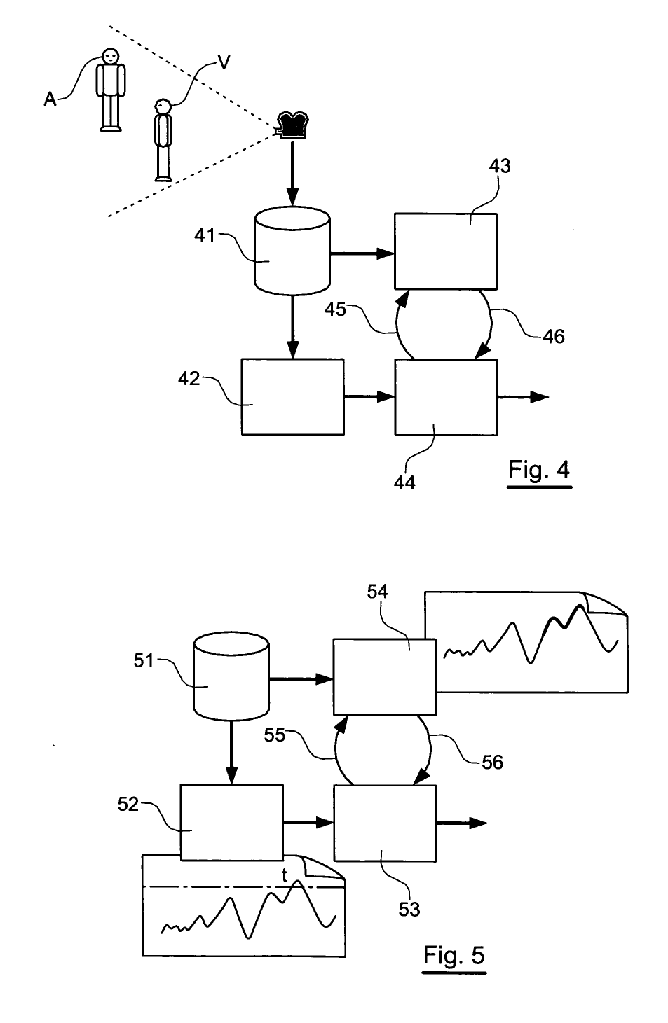

Referring now to FIG. 4, we present a second example of an implementation of the invention for the automatic interpretation of video surveillance scenes.

This example involves the recognition of certain sequences of events from a surveillance video sequence 41 (parking lot, counter, subway station, etc), and cross-checking them against a database of the scenarios to be recognized. These events may come especially from different sources (several cameras, presence detectors etc).

For example, a chronicle of aggression against a person is defined as follows:

1. Entry of an individual into the field of a camera;

2. Entry of another individual into the field of a camera;

3. The two individuals approach each other;

4. One of the two individuals (A) strikes the other (V);

5. The victim V falls to the ground;

6. The aggressor A moves away.

The set of events 1, 2, 3 and 6 describing this scenario are video primitives that are easy to extract by means of motion detection algorithms. These are therefore easily detectable elementary events.

However, the fact that one individual has struck another (event 5) and that his counterpart has fallen to the ground (event 6) calls for finer analysis (that is costlier in computing time) using specific algorithms. These are therefore complex events.

It can be assumed especially that there are several specific algorithms that can be used to compute a corresponding number of specific motions (for example the fact of striking a blow): it is not desirable to execute all these algorithms permanently in order to detect every possible event.

Thus, according to an embodiment of the invention, the motion detection module 42 sends the entry and exit events for a defined zone (event 1 then 2, then 3 and finally 6) to a recognition module 44.

The recognition module 44, also called a scenario-interpretation module, must check whether the individual who has remained fell between the events 3 and 6, deeming this motion to be simpler to compute than the fact of striking a blow (and therefore one that has a lower level of complexity). This module therefore asks (45) a specific detection module 43 to analyze the video sequence 41 between the instants t1 and t2 corresponding to the occurrences of the event 3 and the event 6. Indeed, on the basis of the events already received, the specific algorithms of the particular motion that is missing will be activated on a determined time window.

If the specific detection 43 reports (46) an event consisting of a fall, this event will correspond to the step 5 of the scenario. This scenario interpretation module 44 then asks (45) the detection module 43 to verify the presence of a “blow struck” motion between the instants t1 and t2 corresponding to the occurrences of the events 3 and 5.

If there is a positive response, the aggression scenario is recognized.

Thus, an embodiment of the invention can be used especially to remove the need for constantly computing specific motions, namely complex events. Indeed, according to the invention, this computation will be activated only when all the elementary events (basic elements) of a scenario have been recognized.

4. Third Example of Implementation of the Invention

Finally, referring to FIG. 5, a third example is presented of an implementation of the invention based on the observation of some of the parameters of a system. These parameters evolve in time. In this example, we consider the case where they are measured continuously and are therefore expressed in the form of curves.

In this case, it is the analysis of these curves that produces the observed events which are then integrated into chronicles. Some of these events (such as for example the crossing of thresholds) are simple to compute and are considered to be elementary events. Others (such as the computation of a moving average in a window) require processing of greater complexity and are therefore considered to be complex events. Finally, others are very costly in terms of computation. An example of such events is a search for a particular pattern in a curve (oscillations, computation of frequency etc). Such events are considered to be high-level complex events.

The chronicle recognition technique of an embodiment of the invention proposes a recognition of elementary events (events simpler to compute) before explicitly asking for a search, in a given time window, of an event that is costlier to determine.

Thus, starting from a set of measured parameters 51, the first step consists in determining at least one chronicle that meets the conditions by which the elementary events are interrelated, for example the detection of crossing of thresholds 52.

The elementary threshold-crossing type events are then transmitted to the recognition module 53.

In particular, this module 53 may ask (55) a module for the detection of particular patterns 54 to launch a search for a pattern (a complex event of the presumed chronicle) on the measurements of parameters between the instants t1 and t2 (determined time slot).

The pattern detection module 54 in turn reads the data coming from the measurements of parameters in a determined time window, and then sends (56) the results of its analysis to the recognition module 53.

The module 53 thus checks whether a chronicle instance is recognized.

An embodiment of the invention thus enables an optimization of the computation time for the online recognition of chronicles, in computing only the complex events necessary for the recognition of a chronicle whereas, in the prior art, every complex event possible on the basis of the elementary events was determined.

Furthermore, when the complex computations are indispensable, the proposed technique makes it possible to determine the time window during which the complex events must come into play.

One or more embodiments of the present disclosure therefore overcome one or more drawbacks of the prior art.

More specifically, one or more embodiments provide a chronicle recognition technique that can be used to improve the efficiency of the real-time supervision of the system.

In particular, one or more embodiments provide a technique that performs a computation of these complex events only when computation is necessary.

One or more embodiments propose a technique of this kind that enables the limiting, in a determined time window, of the computation of complex events.

One or more embodiments propose a technique of this kind that is simple to implement, has low complexity of implementation at the algorithmic level and costs little in computation power.

Although the present invention has been described with reference to preferred embodiments, workers skilled in the art will recognize that changes may be made in form and detail without departing from the spirit and scope of the invention.

What is claimed is:

1. A method of recognition of a chronicle from a set of possible chronicles, each of said chronicles comprising a set of events related to one another by pre-determined conditions, said events comprising elementary events, and complex events corresponding to a specific combination of at least two elementary events, the method comprising:
obtaining a series of elementary events,
determining at least one chronicle, called a presumed chronicle, meeting at least certain of said conditions interrelating said elementary events, from among said set of possible chronicles,
and for each of said presumed chronicles:
identifying at least one complex event that has to be present in said presumed chronicle,
verifying the presence of said complex event from corresponding elementary events, and
confirming the recognition of said chronicle if said complex event or events are present,
so that only the complex events necessary for said recognition are computed.

2. A method of recognition according to claim 1 wherein, for each identified complex event, said verification step is implemented in a time window determined on the basis of said corresponding elementary events and of at least some of said conditions of the presumed chronicle.

3. A method of recognition according to claim 2, wherein said time window starts at the earliest date of occurrence and ends at the latest date of occurrence of said identified complex event.

4. A method of recognition according to claim 2, wherein said time window is defined by the intersection of at least two time intervals computed on the basis of the date of occurrence of at least one elementary event and of the pre-determined conditions.

5. A method of recognition according claim 1, wherein said computed complex events are stored in the form of at least one new elementary event.

6. A method of recognition according to claim 1, wherein said pre-determined conditions are time-related constraints and/or a number of occurrences of at least one predefined event relating the elementary and complex events of a chronicle to one another.

7. A method of recognition according to claim 6, wherein each of said elementary events is stored for a storage period determined from the time-related constraints of said presumed chronicle.

8. A method of recognition according to claim 1, wherein each of the complex events of the set of possible chronicles is associated with a value of computational complexity and wherein, in each of said chronicles, a hierarchical structuring of events is carried out as a function of said value, said identification step identifying the complex events having a value below a predetermined threshold.

9. A device for recognition of a chronicle from a set of possible chronicles, each of said chronicles comprising a set of events related to one another by pre-determined conditions, said events comprising elementary events, and complex events corresponding to a specific combination of at least two elementary events, the device comprising:
means for obtaining a series of elementary events,
means for determining at least one chronicle, called a presumed chronicle, meeting at least certain of said conditions interrelating said elementary events, from among said set of possible chronicles,
and for each of said presumed chronicles:
means for identifying at least one complex event that has to be present in said presumed chronicle,
means for verifying the presence of said complex event from corresponding elementary events, and
means for confirming the recognition of said chronicle if said complex event or events are present,
so that only the complex events necessary for said recognition are computed.

10. A computer program comprising program code instructions for the execution of the steps of the method of recognition of a chronicle from a set of possible chronicles, each of said chronicles consisting of a set of events related to one another by pre-determined conditions, said events comprising elementary events and complex events, and corresponding to a specific combination of at least two elementary events according to claim 1 when said program is executed by a computer.

11. Computer program product comprising computer code instructions recorded in a carrier usable in or by a computer, said program enabling the recognition of a chronicle from a set of possible chronicles, each of said chronicles comprising a set of events related to one another by pre-determined conditions, said events comprising elementary events, and complex events corresponding to a specific combination of at least two elementary events, wherein said computer program product comprises:
computer-readable programming code to perform a step for obtaining a series of elementary events;
computer-readable programming code to perform a step for determining at least one chronicle, called a presumed chronicle, meeting at least certain of said conditions interrelating said elementary events, from among said set of possible chronicles,
and for each of said presumed chronicles:
computer-readable programming code to perform a step for identifying at least one complex event that has to be present in said presumed chronicle;
computer-readable programming code to perform a step for verifying the presence of said complex event from corresponding elementary events;
computer-readable programming code to perform a step for confirming the recognition of said chronicle if said complex event or events are present;
so that only the complex events necessary for said recognition are computed.
